(19) United States
(12) Patent Application Publication
(10) Pub. No.: US 2018/0231937 A1
(43) Pub. Date: Aug. 16, 2018

(54) TWO DEGREE OF FREEDOM MECHANICAL OSCILLATOR

(71) Applicant: Ecole Poytechnique Fédérale de Lausanne (EPFL), Lausanne (CH)

(72) Inventors: Mohammad Hussein KAHROBAIYAN, Neuchâtel (CH); Simon HENEIN, Neuchâtel (CH); ILAN VARDI, Neuchâtel (CH)

(21) Appl. No.: 15/896,584

(22) Filed: Feb. 14, 2018

(30) Foreign Application Priority Data
Feb. 14, 2017 (EP) EP17155984.2

(51) Int. Cl. G04B 17/04; G04B 15/14

(52) U.S. Cl. CPC G04B 17/045; G04B 15/14

(57) ABSTRACT

Mechanical oscillator including an inertial body joined to a support by an elastic system, the elastic system being arranged to confer the inertial body substantially two degrees of freedom in rotation about a point having a substantially fixed relationship with respect to the support, and substantially no degrees of freedom in translation. The elastic system includes at least two rods and an L-shaped beam the rods and the L-shaped beam being situated in a single plane when the inertial body is in a neutral position.

### PRIORITY

The present application claims priority of European application EP17155984.2, herewith incorporated by reference in its entirety.

### TECHNICAL FIELD

The present invention relates to the field of mechanical oscillators. More specifically, it relates to a two degree-of-freedom (DOF) mechanical oscillator intended for use as a timebase in a timepiece without a conventional escapement.

### STATE OF THE ART

Horological escapements are well-known to their discretization of time which produces stop and go motion of the drive train resulting in energy losses such as audible ticking. On the other hand, 2-DOF oscillators can produce unidirectional trajectories which can be maintained by a simple crank mechanism, resulting in more efficient continuous motion. 2-DOF oscillators producing unidirectional trajectories are known as IsoSpring, see the publication S. Henein, I. Vardi, L. Rubbert, R. Bitterli, N. Ferrier, S. Fifanski, D. Lengacher, IsoSpring : vers la montre sans échappement, Actes de la Journée d′Etude de la SSC 2014, 49-58.

In order to be acceptable timebases, 2-DOF oscillators should be isochronous, and specifications for this were first given by Isaac Newton in 1687 in his Principia Mathematica, Book I, Proposition X: There must be a central isotropic linear restoring force; see the above-mentioned references for details. Newton showed that the resulting motion lies in a single plane.

The first 2-DOF oscillators produced by the applicant were based on XY stages and described in EP2894521, then analyzed scientifically in the paper L. Rubbert, R. A. Bitterli, N. Ferrier, S. K. Fifanski, I. Vardi and S. Henein, Isotropic springs based on parallel flexure stages, Precision Engineering 43 (2016), 132-145. These are translational oscillators, where the oscillating mass undergoes pure translation.

These oscillators have the disadvantage that their functionality is affected by a change of orientation with respect to gravity, and are hence unsuitable for application to a portable timepiece since they do not respect Newton's specifications unless they retain the same orientation with respect to gravity.

The conditions for isochronism are:
Central restoring force: The oscillator restoring force should always be towards a single neutral point.
Linear restoring force: The oscillator restoring force should be linear with respect to radial distance from the neutral point.
Stiffness isotropy: Stiffness should be independent of the direction of the displacement of the inertial mass.
Mass isotropy: Oscillator mass should be independent of its position.
Planar motion: The oscillating mass should move in a single plane.

Moreover, since the main motivation for the oscillators considered here is to use them as time bases for portable timekeepers such as wristwatches, they should also satisfy:
Gravity insensitivity: Stiffness should be insensitive to gravity.
Linear shock insensitivity: Oscillator kinematics should be insensitive to linear shocks.
Angular shock insensitivity: Oscillator kinematics should be insensitive to angular shocks.
Compatibility with small-scale fabrication: Oscillator design should be compatible with small-scale fabrication, particularly, to be suitable for micro-fabrication applications such as wrist watches.

The document WO2015/104693, in the name of the present applicant, describes a purely rotational 2-DOF spherical oscillator (10), illustrated in FIG. 1.

This oscillator comprises an inertial mass formed as a rigid spherical body (1) connected to a support (0) by an elastic system comprising four flexible rods (2)-(5). Three of these rods (2)-(4) are substantially elastically identical and are located in the x-y plane which is referred to in the following description as the equatorial plane. A fourth rod (5) is located along the z-axis is referred to as the polar axis, which intersects the center of mass of the inertial body 1. Rods (2)-(4) are angularly distributed around the z-axis by a 120-degree rotation about said axis. The center of mass of the body (1) is located at the intersection of the equatorial plane and the polar axis (point O). Point O is also the center of rotation of the body. The cross-section of the fourth rod (5) should be area moment of inertia symmetric, i.e., it should have a diagonal matrix of area moments of inertia with two identical elements. A circle and a square are common examples for such cross-sections. The equatorial plane should intersect rod (5) at ⅛ the distance of the rod length from its clamping point into spherical body (1), this in order to minimize the parasitic shift of the center of rotation.

Due to the spherical symmetry of the oscillating mass, this oscillator is less dependent on the orientation of gravity than translational oscillators. The spherical oscillator does, however, present several drawbacks.

The spherical oscillator does not respect all of Newton's specifications, so is not isochronous.

Although isochronism is no longer theoretically possible, it is still possible, with a suitable restoring force, to obtain a weaker form of isochronism which we call circular isochronism. By this we mean that all purely circular orbits have the same period. The suitable restoring force achieving this is described in patent WO2015/104693, and is termed “scissors law.”

Although stiffness isotropy is generally good in most orientations, as is its gravity insensitivity, a displacement of the center of mass of the spherical oscillator represents a parasitic shift in the equatorial plane caused by the shortening of the equatorial rods when they are subject to bending due to body rotation. This parasitic shift leads to large stiffness anisotropy when gravity has a component in the equatorial plane. Since stiffness is affected by gravity when this plane contains a component of the gravity vector, it must be concluded that the spherical oscillator is gravity sensitive.

Furthermore, although this oscillator is insensitive to angular shock around the polar axis, it remains sensitive to angular shocks about the other axes.

Finally, the spherical form of the inertial mass is largely incompatible with the microfabrication techniques commonly used to produce elements of wrist watches.

An object of the invention is thus to at least partially overcome the above-mentioned drawbacks of the prior art.

### SUMMARY OF THE INVENTION

To this end, the invention concerns a mechanical oscillator comprising an inertial body joined to a support by means of an elastic system, said elastic system being arranged to confer (i.e. provide) said inertial body substantially two degrees of freedom in rotation about a point having a substantially fixed relationship with respect to said support, and substantially no degrees of freedom in translation. Said point may be at the intersection between a polar axis and a mid-plane of the oscillator.

According to the invention, the elastic system comprises at least two rods and an L-shaped beam, at least said rods, and also ideally said beam, being situated, when said inertial body is in a neutral position (i.e. when it is at rest), in a single plane. An L-shaped beam, in this context, may comprise two straight leaf springs joined at an angle to each other such that their mid-planes intersect along a line. The L-shaped beam can either be situated in the same plane as the rods when the inertial body is in its neutral position, or can be in a parallel plane.

As a result, a 2-DOF oscillator is proposed which has circular isochronism, at least in certain orientations, and which is suitable for integration in a portable timepiece such as a watch, and which can conveniently be manufactured by contemporary micromachining methods, e.g., by etching from one or more plates of material, additive manufacturing, or similar. The exact process depends on whether the L-shaped beam is in the same plane as the rods (in which case the entire oscillator takes up less height and can be fabricated easily from a single plate of material), or lies in a parallel plane.

Advantageously, said L-shaped beam is formed from two straight leaf springs joined at an angle to each other, and wherein said point lies on a locus defined by the intersection of the mid-planes of the said straight leaf springs.

Advantageously, said rods are substantially elastically identical and are evenly angularly spaced around said point. These rods ideally are three in number.

In one configuration, the inertial body surrounds said support, whereas in another configuration, the support is disposed to the outside of said inertial body, in the plane thereof, and may surround it at least partially.

In another configuration, the mechanical oscillator further comprises an intermediate body connected to said support by means of said two rods, and is connected to said inertial body by means of at least one beam. The inertial body is further connected to said support by at least two rods which are substantially elastically identical and are evenly angularly spaced in the plane of the oscillator around said point. This type of oscillator is referred to as a “compound oscillator”.

Advantageously, the inertial body is substantially annular and surrounds said intermediate body, maximizing its inertia and its freedom of angular movement.

The invention further relates to a mechanical oscillator system comprising at least two mechanical oscillators as defined above, the inertial bodies of each of said mechanical oscillators being kinematically coupled. The isochronism of the system can thus be improved, and its sensitivity to the direction of the gravity vector can be reduced.

The inertial bodies of the system can be kinematically coupled by two L-shaped beams.

In a particular embodiment, the mechanical oscillator system may comprise four mechanical oscillators of any type as defined above. A first inertial body, which belongs to a first of said oscillators, is kinematically coupled to a second inertial body belonging to a second of said oscillators by two L-shaped beams. This second inertial body is kinematically coupled to a third inertial body belonging to a third of said oscillators, by means of one further L-shaped beam. This third inertial body is kinematically coupled to a fourth inertial body belonging to a fourth of said oscillators by one yet further L-shaped beam, and this fourth inertial body is coupled to said first inertial body by two yet further L-shaped beams.

A mechanical oscillator system which is entirely insensitive to the direction of the gravity vector is thus proposed, in terms of both gravity insensitivity and sensitivity to angular shocks. Furthermore, this system transmits no torque to the support during oscillations, improving its efficiency and thus its Q-factor.

In this arrangement, the rods of said first oscillator are preferably related to the rods of the said third oscillator by a 180-degree rotation in the plane and a translation, and the rods of said second oscillator and said fourth oscillator are likewise related to each other by a 180-degree rotation about their respective combined center of gravity.

In another construction, the mechanical oscillator system may comprise two non-compound oscillators as defined above. These oscillators constitute a first and second oscillator respectively. The system further comprises one compound oscillator constituting a coupling element, linking the first and second oscillators.

In this construction, first inertial body of the first oscillator is advantageously kinematically linked to a body belonging to said coupling element by means of two L-shaped beams, and the inertial body of the second oscillator is advantageously kinematically linked to said body belonging to said coupling element by means of two further L-shaped beams.

In this construction, complete gravity and angular shock insensitivity can be achieved with only three cores, making the system more compact and more economic to manufacture than the four-oscillator variant defined above.

Advantageously, each rod of said first oscillator is related to a corresponding rod of said second oscillator by a 180-degree rotation about a polar axis of said first oscillator and a translation.

In each embodiment of a mechanical oscillator system, the mechanical oscillators, in their neutral positions (i.e. when they are at rest), advantageously lie in a single plane, making fabrication simple.

It should be noted that all the above-mentioned aspects of the invention can be combined in any manner which makes technical sense.

### BRIEF DESCRIPTION OF THE DRAWINGS

The invention will now be described in reference to the appended figures, which illustrate:

FIG. 1: a schematic isometric view of the above-mentioned prior art spherical oscillator;

FIG. 2: a plan and an isometric view of an embodiment of a mechanical oscillator according to the invention;

FIG. 3: two plan views and an isometric view of an embodiment of a mechanical oscillator system according to the invention;

FIGS. 4a-b: two plan views and an isometric view of a further embodiment of a mechanical oscillator system according to the invention;

FIG. 5: a plan view and an isometric view of the corner of an L-shaped beam flexure;

FIG. 6: a plan view and an isometric view of a further embodiment of a mechanical oscillator according to the invention; and

FIGS. 7a-b: two plan views and an isometric view of a further embodiment of a mechanical oscillator system according to the invention.

### EMBODIMENTS OF THE INVENTION

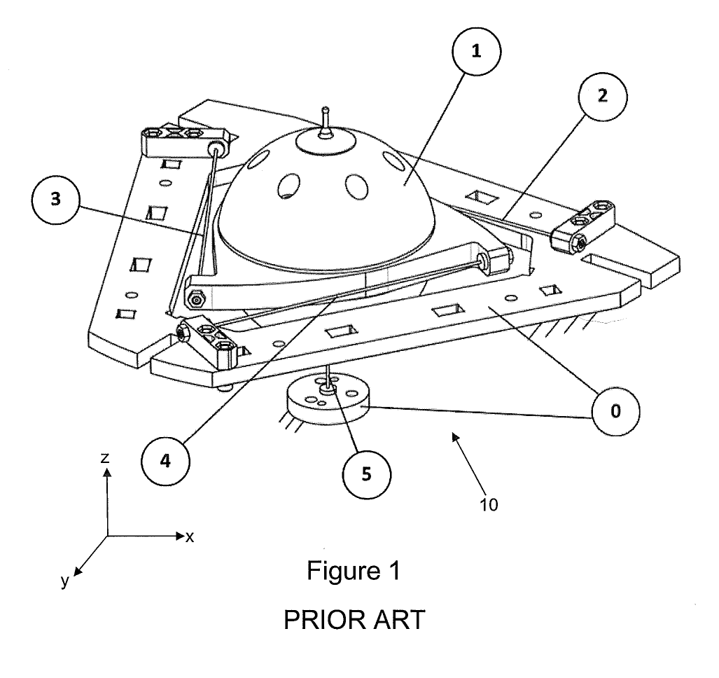

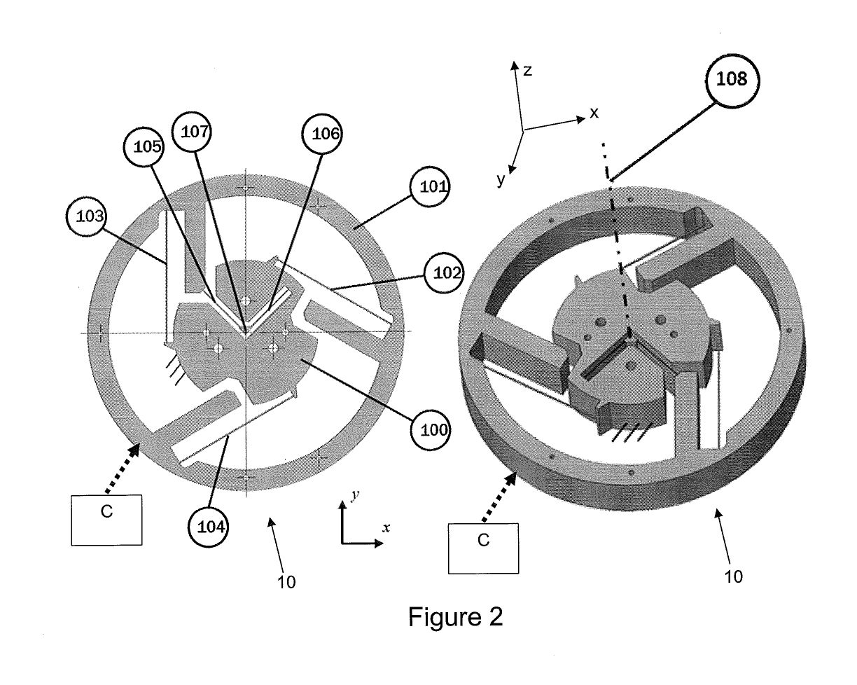

FIG. 2 illustrates a first embodiment of a mechanical oscillator (10) according to the invention. This embodiment is a single-core oscillator, which is similar in kinematics to that of FIG. 1, except that it has been rationalized into a planar form suitable for microfabrication. In essence, the fourth rod (5) of FIG. 1 has been replaced by an L-shaped flexure (105), (106), as will be described in more detail below. Such a transition from a polar rod to an L-shaped flexure is conceptually non-trivial. In all the embodiments described below, the L-shaped flexure is in the same plane as the rods (see below), which gives a particularly compact oscillator, however it can be in a different, parallel plane and still function correctly.

This oscillator (10) comprises an inertial body (101) formed as an annulus which is connected to a rigid support (100) by an elastic system comprising three elastically-identical rods (102)-(104) arranged at 120-degree angular intervals with respect to each other about polar axis (108), and an L-shaped flexure with elastically-identical orthogonal blades (105) and (106) connected to each other via a rigid corner (107). Polar axis (108) coincides with the intersection line of mid-planes of the two individual blades (105) and (106) which constitute the L-shaped flexure. The center of mass of the body is at the intersection of polar axis (108) and the x-y plane (the oscillator (10) is symmetric with respect to x-y plane).

It should also be noted that the annulus (101) can constitute the fixed support, and the element indicated as a support (100) can constitute the inertial body.

Like the spherical oscillator of FIG. 1, the inertial body (101) has a first degree of freedom in rotation around the x axis, a second degree of freedom in rotation around the y axis, and substantially no other degree of freedom, either in rotation or in translation. While it is impossible to absolutely prevent any movement at all in other potential degrees of freedom since any structure can be deformed in compression or tension according to Hooke's law, it is considered that a stiffness exceeding 100, preferably 1,000, further preferably 10,000, times the stiffness of at least one of the intended degrees of freedom around the axes x and y as described above is substantially rigid and hence does not constitute a degree of freedom in the sense of this patent. This applies equally to all the other embodiments detailed below, and will not be repeated ad nauseam.

As a result, the inertial body (101) can carry out an orbital, tilting rotation, similar to a disc spinning on a flat surface but with a constant period of rotation, with the normal to the plane of the inertial body (101) thus rotating around the polar axis (108). This rotation can be maintained e.g. by means of a crank arrangement (C), illustrated schematically, or any other convenient arrangement to stimulate and drive the oscillations of the inertial body (101).

It should be noted that the exact shapes of the components of the oscillator (10) are arbitrary, and can be changed according to the needs of the constructor, for aesthetic purposes, etc.

In this embodiments, stiffness isotropy is achieved, but is however sensitive to gravity, and the oscillator (10) is insensitive to angular shock about the polar axis but sensitive to other angular shocks.

This oscillator (10) is compatible with microfabrication techniques, as are all the other embodiments described below.

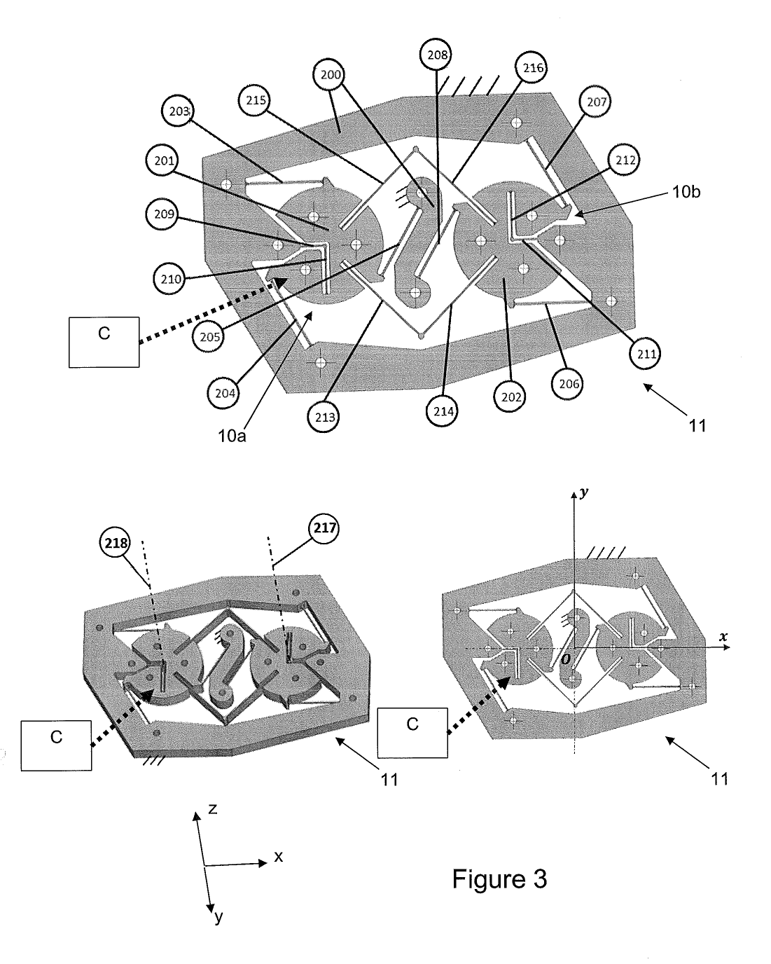

FIG. 3 illustrates a further embodiment of a mechanical oscillator system (11), comprising two “cores”, each being an individual oscillator (10a), (10b), and these terms are interchangeable. Each of these cores (10a), (10b) comprises an inertial body (201), (202), which are substantially inertially identical one with respect to the other, and a set of flexures, which are substantially elastically-identical for each core. A crank mechanism (C) or similar can act on one or more of the inertial bodies (201), (202) as above. The first core (10a) comprises of a first inertial body (201) connected to a support (200) by an elastic system comprising three rods (203)-(205) equally spaced at 120-degree angular intervals one with respect to the other about axis (218), and an L-shaped flexure with orthogonal blades (209) and (210). Axis (218) is the polar axis of the first core (10a) and is the intersection line of the mid-planes of blades (209) and (210), which are again joined by a substantially rigid corner.

The second core (10b) comprises of a second inertial body (202) connected to the support (200) by three rods (206)-(208) again equally spaced one with respect to another at 120-degree angular intervals about axis (217) and an L-shaped flexure with orthogonal blades (211) and (212). Axis (217) is the polar axis of the second core (10b) and is the intersection line of the mid-planes of blades (211) and (212). Rods (203)-(208) are substantially elastically identical. The first and second bodies (201) and (202) are connected by two L-shaped flexures with each comprising two substantially elastically identical orthogonal blades (213), (214) and (215), (216) respectively. Blades (215) and (216) and blades (213) and (214) have mirror symmetry with respect to the x-z plane where z is the axis perpendicular to the x and y axes. Blades (213) and (215) and blades (214) and (216) have mirror symmetry with respect to the y-z plane. Axes (217) and (218) are parallel to the z axis, pass through the x axis and are at the same distance from the y axis. The equatorial rods of the first core (rods (203)-(205)) are disposed a 180 degree rotation with respect to the equatorial rods of the second core (rods (206)-(208)). The center of mass of the first and the second cores (10a), (10b) are at the intersection of axes (218) and (217) with the x-y plane, respectively. The oscillator is symmetric with respect to the x-y plane. Blades (209) and (211) are identical and located along the x axis. Blades (210) and (212) are identical and are parallel to the y axis. Blades (209) and (211) are shorter than blades (210) and (212) in order to achieve stiffness isotropy.

In this embodiment, support (200) comprises an annular outer support, and a smaller inner support situated between the two inertial bodies (201) and (202) in order to provide convenient anchor points for the various flexures.

Seen globally, each core (10a), (10b), including all its flexures, is a 180-degree rotation of the other, about an axis parallel to the z axis and intersecting the xy plane at the combined center of mass of both cores (10a), (10b).

As a result of this structure, the oscillator system (11) has two degrees of freedom in rotation. Each core (10a), (10b) is coupled such that, when one core rotates about the x axis, the other rotates about the x axis with the same angle and in the same direction. When one core rotates about an axis parallel to the y axis and intersecting its own polar axis (217), (218), the other rotates about a corresponding axis parallel to the y axis and intersecting its own polar axis (218), (217) with same angle but in the opposite direction. In other words, each core (10a), (10b) undergoes a tilting orbital motion which is a mirror image in the y-z plane with respect to the other core.

In this variant, stiffness isotropy is achieved, but the stiffness is sensitive to gravity. In respect of angular shocks, there is insensitivity about the y and z axes, but not about the x axis.

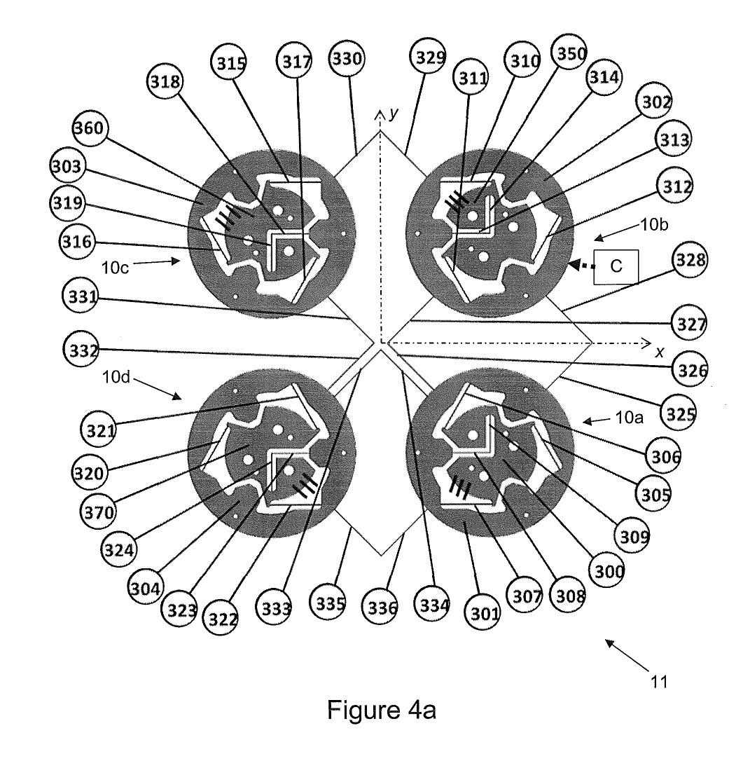

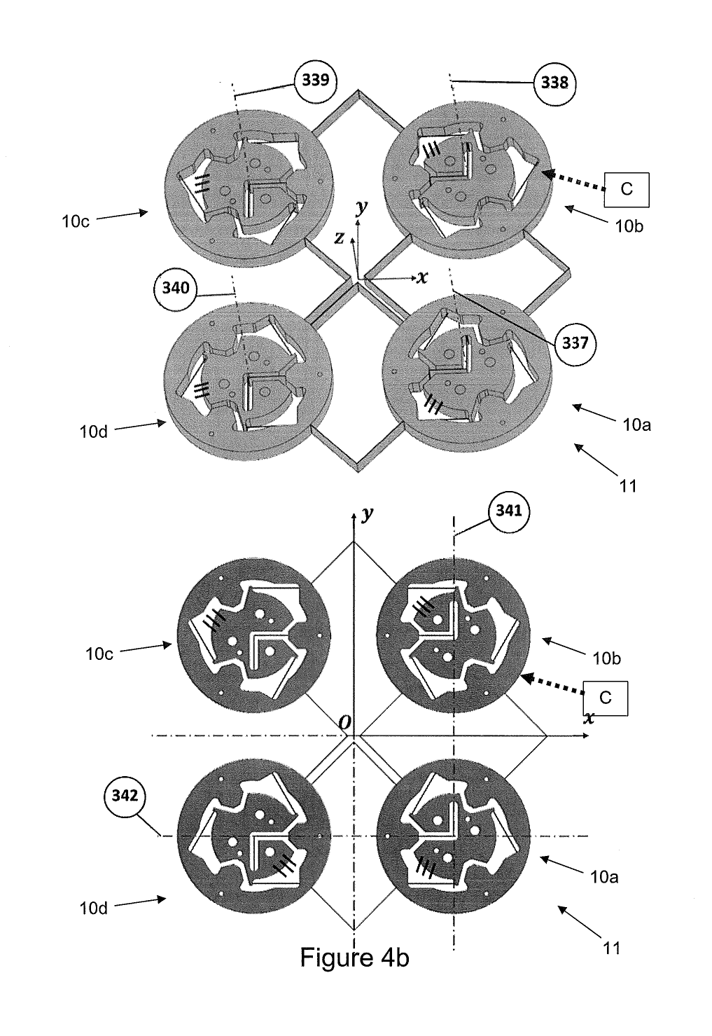

FIGS. 4a and 4b illustrate a further embodiment of a mechanical oscillator system (11) according to the invention. This oscillator (11) comprises four oscillator cores, as defined above, upon which a crank mechanism (C) or similar can act, as described previously.

This quad-core oscillator comprises of four substantially identical single-core oscillators (10a), (10b), (10c), (10d). The first core (10a) comprises a first inertial body (301) connected to a support (300) by an elastic system comprising three rods (305)-(307) equally spaced at a 120-degree angular intervals each with respect to the other about axis (337), and an L-shaped flexure with orthogonal blades (308) and (309). Axis (337) is the polar axis of the first core (10a) and is the intersection line of the mid-planes of blades (308) and (309). The center of mass of the first core (10a) is located at the intersection of polar axis (337) and the x-y plane. The oscillator (10) is symmetric with respect to the x-y plane.

The second core (10b) comprises a second inertial body (302) connected to a support (350) by a further elastic system comprising three rods (310)-(312) equally spaced at a 120-degree angular intervals about axis (338) and an L-shaped flexure with orthogonal blades (313) and (314). Axis (338) is the polar axis of the second core (10b) and is the intersection line of the mid-planes of blades (313) and (314). The center of mass of the second core (10b) is located at the intersection of polar axis (338) and the x-y plane.

The third core (10cc) comprises a third inertial body (303) connected to a support (360) by a further elastic system comprising three rods (315)-(317) equally distributed at a 120-degree angular rotation each with respect to the other about axis (339), and an L-shaped flexure with orthogonal blades (318) and (319). Axis (339) is the polar axis of the third core (10c) and is the intersection line of the mid-planes of blades (318) and (319). The center of mass of the third core is located at the intersection of polar axis (339) and the x-y plane.

The fourth core comprises a fourth inertial body (304) connected to a support (370) by a further elastic system comprising three rods (320)-(322) equally distributed at a 120-degree angular rotation each with respect to the other about axis (340), and an L-shaped flexure with orthogonal blades (323) and (324). Axis (340) is the polar axis of the fourth core (10d) and is the intersection line of the mid-planes of blades (323) and (324). The center of mass of the fourth core is located at the intersection of polar axis (340) and the x-y plane. Rods (305)-(307), (310)-(312), (315)-(317) and (320)-(322) are substantially elastically identical, each with respect to the others. Blades (308), (309), (313), (314), (318), (319), (323), (324) are also substantially elastically identical, each with respect to the others.

The four inertial bodies (301)-(304) are connected by six L-shaped flexures with substantially elastically identical orthogonal blades (325)-(336). Blades (327), (328), (329), (330) and (331), and blades (326), (325), (336), (335) and (332) have mirror symmetry respectively by pairs (i.e. the first listed blade of the first set has this symmetry with the first listed blade of the second listed set and so on; this policy is adhered to throughout the description) with respect to the x-z plane (centered on the combined center of mass of the four cores. Blades (333) and (334) have mirror symmetry with blades (335) and (336) respectively with respect to a plane parallel to the z axis containing axis (342). This axis (342) passes through the centers of mass of the first and fourth cores (10a), (10d). Blades (330), (331), (332), (333) and (335) and blades (329), (327), (326), (334) and (336) respectively have mirror symmetry by pairs with respect to the y-z plane.

Blades (326), (327) and blades (325), (328) respectively have mirror symmetry by pairs with respect to the plane parallel to the z axis containing axis (341). This axis (341) passes through the centers of mass of the first and second cores (10a), (10b). Axes (337)-(340) are parallel to the z axis, equally distributed about point O and are at the same distance from the z axis. Axes (337), (340), and axes (338), (338) have mirror symmetry with respect to the x-z plane. Axes (337), (338) and axes (340), (339) have mirror symmetry with respect to the y-z plane. The rods (305)-(307) of the first core (10a) are at a 180 degree rotation about the z axis with respect to respective rods (315)-(317) of the third core (10c). The rods (310)-(312) of the second core (10b) are at a 180 degree rotation about the z axis with respect to the respective rods (320)-(322) of the fourth core (10d).

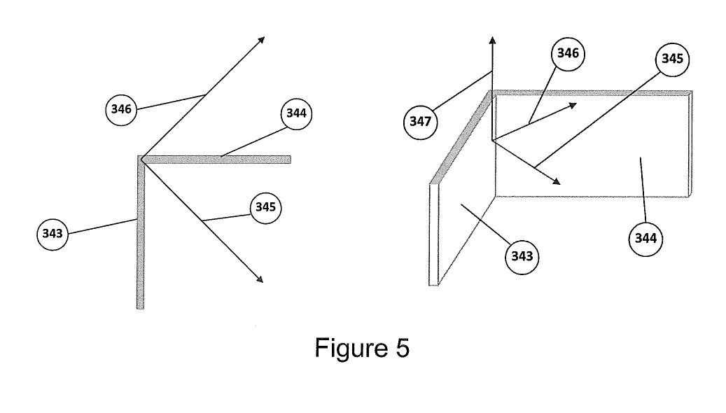

To further explain the functioning of the embodiment of FIGS. 4a and 4b, FIG. 5 depicts an L-shaped flexure comprising of two identical orthogonal blades (343) and (344), corresponding to the L-shaped flexures (308), (309); (313), (314); (318), (319); and (323), (324) of the oscillator system (11) of FIGS. 4a and 4b. Axis (347) coincides with intersection of the mid-planes of blades (343) and (344). Axis (345) is the intersection of two planes of symmetry of the L-shaped flexure (343), (344), and is referred to as the “strong” axis. Axis (346) is perpendicular to both axes (347) and (345) at their point of intersection, and is referred to as the “weak” axis.

The plane containing axes (345) and (346), and the plane containing axes (345) and (347) are the symmetry planes of the L-shaped flexure (343), (344). Consider the L-shaped flexure subject to a torque in the plane defined by axes (345) and (346): it produces maximum restoring torque when the applied torque is about the strong axis (345) and the minimum restoring torque when the applied torque is about the weak axis (346). The configuration of the L-shaped flexures located at the core centers, i.e. those with blades (308), (309), (313), (314), (318), (319), (323) and (324), is such that when two cores rotate about their strong axes, the other two rotate about their weak axes. The configuration of L-shaped flexures of FIGS. 4a and 4b has this property.

Due to the structure outlined above, the quad-core oscillator of FIGS. 4a and 4b has two degrees of freedom in rotation. When the first core (10a) rotates about an axis parallel to the x axis and intersecting the axis 337, the fourth core (10d) rotates about a corresponding axis parallel to the x axis and intersecting polar axis (340) with the same angle in the same direction, and the second and third cores (10b), (10c) rotate about corresponding axes parallel to the x axis and intersecting axes (338) and (339) respectively with the same angle but in the opposite direction. When the first core (10a) rotates about an axis parallel to the y axis and intersecting the polar axis (337), the second core rotates about an axis parallel to the y axis and intersecting the polar axis (338) with the same angle in the same direction and the third and the fourth cores (10c), (10d) rotate about corresponding axes parallel to the y axis and intersecting axes (339) and (340) respectively, with the same angle but in the opposite direction.

In other terms, each core (10a)-(10d) oscillates with an orbital tilting motion in mirror image to each of its neighboring cores considered parallel to the x and y axes (i.e. not considering diagonally-separated pairs of cores (10a)-(10d)), the planes of reflection being orthogonal to, and intersecting the midpoint of, the line of centers of each such pair of cores (10a)-(10d), and hence coinciding with the x-z and y-z planes.

Due to the above-mentioned geometry, stiffness isotropy is achieved, and this stiffness is insensitive to gravity due to the 180-degree angular shift between the rods of the first and third cores (10a), (10c), and that of the second and fourth cores (10b), (10d).

Furthermore, this oscillator (10) transmits no torque to the support (300), (350), (360), (370), which results in an increase in quality factor since no parasitic forces are transmitted to said support (300), (350), (360), (370) and thus a maximum of kinetic energy is retained within the oscillator (10).

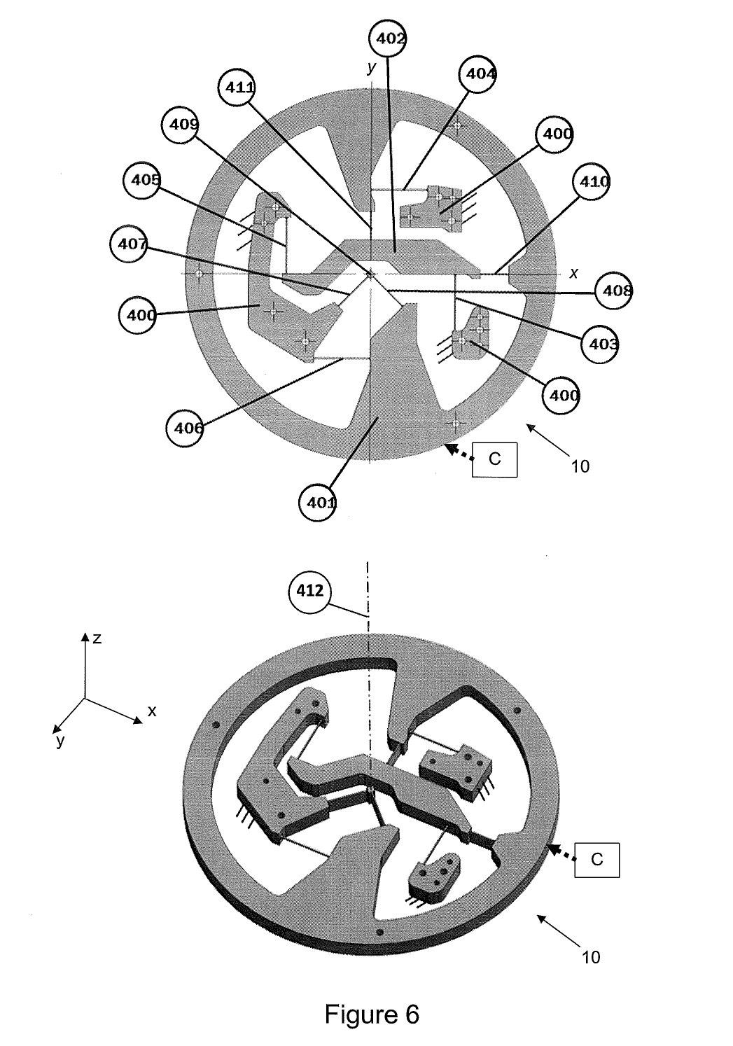

FIG. 6 illustrates a further embodiment of an oscillator (10) according to the invention, referred to here as a “compound-single-core” oscillator, which can be actuated by a crank mechanism (C) acting on one or more of the cores as discussed above.

The compound-single-core comprises a first inertial body (401) connected to a support (400) by a further elastic system comprising an L-shaped flexure (407), (408) and two rods (404) and (406) which are related by a 180-degree rotation about polar axis (412). The L-shaped flexure comprises substantially elastically identical orthogonal blades (407) and (408) joined by a rigid corner (409). Polar axis (412) is the intersection line of the mid-planes of blades (407) and (408), and intersects the center of gravity of the core. The inertial body (401) is connected to an intermediate body (402) by a blade (410) extending along the x-axis and blade (411) extending along the y-axis, the origin of the x and y axes being coincident with polar axis (412). The intersection of the mid-planes of blades (410) and (411) is polar axis (412). Intermediate body (402) is connected to a support (400) by rods (403) and (405) which are related by a 180-degree rotation about axis (412). Rods (403)-(406) are substantially elastically identical and related by a 90-degree rotation about polar axis (412). The center of mass of the oscillator body is located at the intersection of polar axis (412) and the x-y plane. The oscillator is symmetric with respect to the x-y plane.

Inertial body (401) and intermediate body (402) can, in principle, have opposite roles, intermediate body (402) becoming then an inertial body comprising the bulk of the inertia of the core, inertial body (401) being in that case relatively light.

Due to the arrangement of flexures, inertial body (401) and intermediate body (402) rotate together as a single, substantially rigid body.

With this arrangement, stiffness isotropy is achieved, and this stiffness is insensitive to gravity due to the rod (403) being related to rod (404) via a 90-degree rotation about polar axis (412), and rod (405) being likewise related to rod (406). This embodiment is insensitive to angular shocks about the polar axis (412) (i.e. the z-axis), but is however sensitive to all other angular shocks.

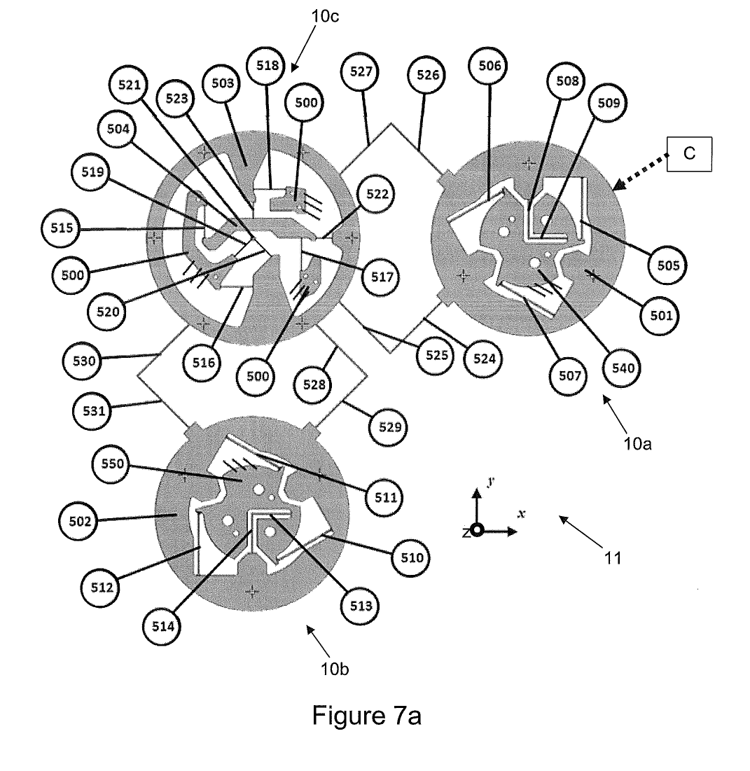

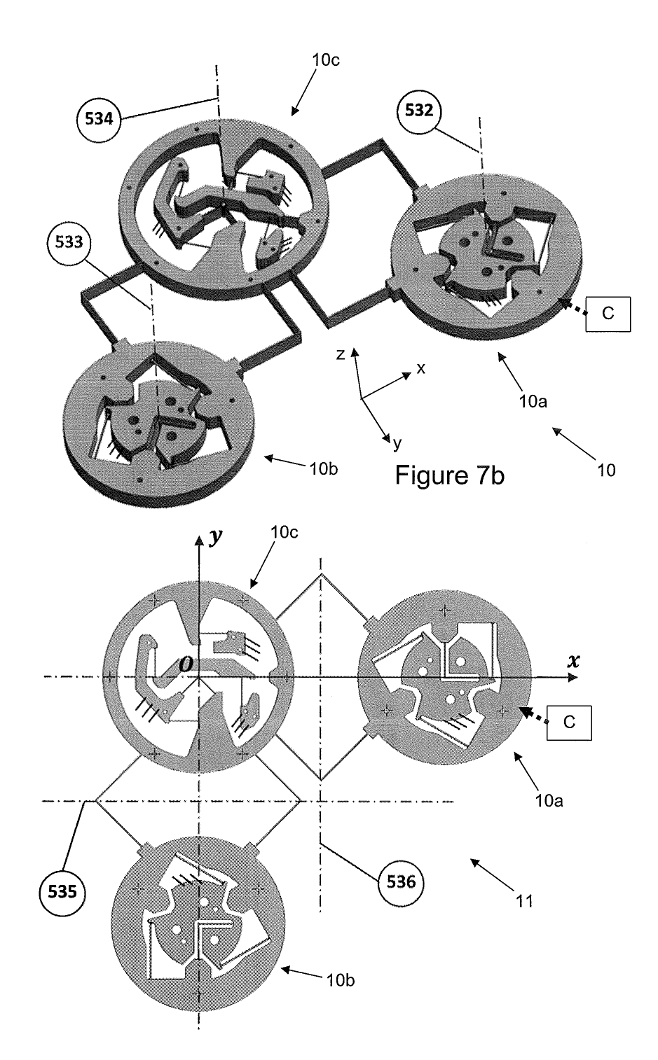

FIGS. 7a and 7b illustrate a yet further embodiment of a mechanical oscillator system (11) according to the invention, referred to as a “compound-dual-core” oscillator.

This oscillator comprises two identical cores (10a), (10b) and a coupling element (10c). A crank mechanism (C) can be arranged to interact with one or more cores (10a)-(10c). A first core (10a) comprises a first inertial body (501) connected to a support (540) by an elastic system comprising three rods (505)-(507) evenly angularly spaced by a 120-degree rotation about axis (532), and an L-shaped flexure with orthogonal blades (508) and (509). Axis (532) is the polar axis of the first core (10a) and coincides with the intersection of mid-planes of blades (508) and (509).

The second core (10b) comprises a second inertial body (502) connected to a support (550) by a further elastic system comprising three rods (510)-(512) evenly angularly spaced by a 120-degree rotation about axis (533), and an L-shaped flexure with orthogonal blades (513) and (514). Axis (533) is the polar axis of the second core (10b) and is the intersection of mid-planes of blades (513) and (514).

The coupling element (10c), which is similar to the core illustrated in FIG. 6, comprises two rigid bodies (503) and (504), and a further elastic system comprising four rods (516)-(519) evenly angularly spaced by a 90-degree rotation about axis (534), two blades (522) and (523) extending along axes intersecting axis (534) and parallel to the x and y-axes respectively, and an L-shaped flexure with identical orthogonal blades (519) and (520) joining at a rigid corner (521). Axis (534) is the polar axis of the coupling element (10c) and coincides with the intersection of mid-planes of blades (519) and (520). Rods (505)-(507) and (510)-(512) are substantially elastically identical. Rods (505)-(507) are angularly related to rods (510)-(512) by a 180-degree rotation about polar axis (532) and a translation. Blades (508), (509), (513) and (514) are substantially elastically identical. They are arranged such that when one core rotates about its strong axis (see above), the other rotates about its weak axis.

The cores are connected to the coupling element (10c) by four L-shaped flexures with substantially elastically identical orthogonal blades (524)-(531). Additional mass-contributing oscillating bodies can be mounted on first and second inertial bodies (501) and (502), so the mass of the coupling element (10c) can be considered as being negligible by comparison.

The center of masses of the first and second cores (10a), (10b) are at the intersection of axes (532) and (533) and the x-y plane. The oscillator system (11) is symmetric with respect to the x-y plane. Blades (524)-(525) and blades (526)-(527) have respective mirror symmetry by pairs (as defined above, i.e. blade (524) with respect to blade (526), and blade (525) with respect to blade (527)) with respect to a plane defined by the z-axis and the line of centers between the first core (10a) and the coupling element (10c). Blades (528)-(529) and blades (530)-(531) have respective mirror symmetry by pairs with respect to a plane defined by the z axis and the line of centers between the second core (10b) and the coupling element (10c). Blades (524) and (526) and blades (525) and (527) have respective mirror symmetry by pairs with respect to the plane parallel to the z axis and passing through polar axis (536). Blades (528) and (530) and blades (529) and (531) have mirror symmetry with respect to the plane parallel to the z axis passing through axis (535). Axis (535) is parallel to the x axis and has the same distance from polar axes (533) and (534). Polar axis (536) is parallel to the y axis and has the same distance from polar axes (532) and (534). The polar axis (532) of the first core (10a) and the polar axis (533) of the second core (10b) are equidistant from the polar axis (534) of the coupling element (10c).

The coupling element (10c) is a compound-single-core oscillator. It can be replaced by a non-compound single-core oscillator (like the one depicted in FIG. 2) but in that case, gravity sensitivity will be slightly worse.

As a result of this construction, the compound-dual-core oscillator has two degrees of freedom in rotation about axes parallel to the x and y axes. When one core (10a), (10b) rotates about its respective axis parallel to the x axis and intersecting its polar axis, the other (10b), (10a) rotates about its corresponding axis with the same angle but in the opposite direction, and similarly with rotations around its respective axis parallel to the y axis.

As a result, the two cores (10a), (10b) undergo tilting orbital motion with a 180-degree phase shift one with respect to the other.

With this arrangement, stiffness isotropy is achieved in a manner which is insensitive to gravity, and the oscillator (10) is insensitive to all angular shocks due to the 180-degree phase shift in rotations of the first and second cores (10a), (10b). In this embodiment, these dynamics are achieved with only three cores (10a), (10b), (10c) rather than the four required in the embodiment of FIGS. 4a and 4b.

In all of the foregoing embodiments, it should be noted that the various supports can each be a single piece, or may be individual pieces not linked directly to each other. These supports can be attached to a framework component of a timepiece so as to create a timepiece comprising the oscillator (10) and/or oscillator system (11) of the invention.

The oscillators (10) and oscillator systems (11) described above can be fabricated by conventional micromachining, e.g. by masking and etching from a plate of material, stereolithography, LIGA, 3D printing, irradiation of a photostructurable material with a femtometer laser then etching, and so on. In the case of the L-shaped beam being in a different plane to the rods, an additive process, a laser-based photostructuring process, or a multi-layer process would be most appropriate.

In terms of suitable materials, various metals and alloys can be used, in monocrystalline, polycrystalline or amorphous forms, as can various non-metals such as silicon, silicon oxide, silicon nitride, silicon carbide, alumina in all its forms, diamond-like-carbon or similar. These materials may be coated with another material.

Furthermore, each inertial body can have extra mass added thereto to increase its inertia, e.g. by attaching a supplementary piece made of a relatively dense material such as a metal.

Although the invention has been described in connection with specific embodiments, variations thereto are possible without departing from the scope of the invention as defined in the appended claim.

1-19. (canceled)

20. Mechanical oscillator comprising an inertial body joined to a support by means of an elastic system, said elastic system being arranged to confer said inertial body substantially two degrees of freedom in rotation about a point having a substantially fixed relationship with respect to said support and substantially no degrees of freedom in translation,
characterized in that said elastic system comprises at least two rods and an L-shaped beam, said rods being situated in a single plane when said inertial body is in a neutral position.

21. Mechanical oscillator according to claim 20, wherein said L-shaped beam is formed from two straight leaf springs joined at an angle, and wherein said point lies on a locus defined by the intersection of the mid-planes of the said leaf springs.

22. Mechanical oscillator according to claim 20, wherein said rods are substantially elastically identical and are evenly angularly spaced around said point.

23. Mechanical oscillator according to claim 22, comprising at least three rods which are substantially elastically identical and are evenly angularly spaced around said point.

24. Mechanical oscillator according to claim 20, wherein said inertial body surrounds said support.

25. Mechanical oscillator according to claim 20, wherein said support is disposed to the outside of said inertial body in the plane thereof.

26. Mechanical oscillator according to claim 20, further comprising an intermediate body connected to said support by means of said two rods and connected to said inertial body by means of at least one beam, said inertial body being connected to said support by at least two rods which are substantially elastically identical and are evenly angularly spaced around said point.

27. Mechanical oscillator according to claim 26, wherein said inertial body is substantially annular and surrounds said intermediate body.

28. Mechanical oscillator system comprising at least two mechanical oscillators according to claim 20, the inertial bodies of each of said mechanical oscillators being kinematically coupled.

29. Mechanical oscillator system according to claim 28, wherein said inertial bodies are kinematically coupled by two L-shaped beams.

30. Mechanical oscillator system according to claim 28, comprising four of said mechanical oscillators, a first inertial body belonging to a first of said oscillators being kinematically coupled to a second inertial body belonging to a second of said oscillators by two L-shaped beams, said second inertial body being kinematically coupled to a third inertial body belonging to a third of said oscillators by one further L-shaped beam, said third inertial body being kinematically coupled to a fourth inertial body belonging to a fourth of said oscillators by one yet further L-shaped beam, said fourth inertial body being coupled to said first inertial body by two yet further L-shaped beams.

31. Mechanical oscillator system according to claim 30, wherein the rods of said first oscillator and the rods of said third oscillator are related to each other by a 180-degree rotation in said plane and a translation, and the rods of said second oscillator and the rods of said fourth oscillator are likewise related to each other by a 180-degree rotation in said plane and a translation.

32. Mechanical oscillator system comprising first, second, and third oscillators according to claim 20, the third oscillator further comprising an intermediate body connected to said support by means of said two rods and connected to said inertial body by means of at least one beam, said inertial body being connected to said support by at least two rods which are substantially elastically identical and are evenly angularly spaced around said point, said third oscillator constituting a coupling element.

33. Mechanical oscillator system according to claim 32, wherein the first inertial body of the first oscillator is kinematically linked to a body belonging to said coupling element by means of two L-shaped beams, and wherein the inertial body of the second oscillator is kinematically linked to said body belonging to said coupling element by means of two further L-shaped beams.

34. Mechanical oscillator system according to claim 32, wherein each rod of said first oscillator is related to a corresponding rod of said second oscillator by a 180-degree rotation about the polar axis of said first oscillator and a translation.

35. Mechanical oscillator system according to claim 28, wherein said mechanical oscillators, when in their neutral positions, lie in a single plane.

36. Mechanical oscillator system comprising first, second, and third oscillators according to claim 20, the third oscillator further comprising an intermediate body connected to said support by means of said two rods and connected to said inertial body by means of at least one beam, said inertial body being connected to said support by at least two rods which are substantially elastically identical and are evenly angularly spaced around said point, wherein said inertial body is substantially annular and surrounds said intermediate body, said third oscillator constituting a coupling element.

37. Mechanical oscillator system according to claim 36, wherein the first inertial body of the first oscillator is kinematically linked to a body belonging to said coupling element by means of two L-shaped beams, and wherein the inertial body of the second oscillator is kinematically linked to said body belonging to said coupling element by means of two further L-shaped beams.

38. Mechanical oscillator system according to claim 36, wherein each rod of said first oscillator is related to a corresponding rod of said second oscillator by a 180-degree rotation about the polar axis of said first oscillator and a translation.
